(19) United States
(12) Patent Application Publication
(10) Pub. No.: US 2010/0054272 A1
(43) Pub. Date: Mar. 4, 2010

(54) STORAGE DEVICE CAPABLE OF ACCOMMODATING HIGH-SPEED NETWORK USING LARGE-CAPACITY LOW-SPEED MEMORY

(75) Inventors: Hisashi IWAMOTO, Tokyo (JP); Yasuto Kuroda, Tokyo (JP); Yuji Yano, Tokyo (JP); Kazunari Inoue, Tokyo (JP)

Correspondence Address: MCDERMOTT WILL & EMERY LLP, 600 13TH STREET, N.W., WASHINGTON, DC, 20005-3096, US

(73) Assignee: RENESAS TECHNOLOGY CORP.

(21) Appl. No.: 12/550,723

(22) Filed: Aug. 31, 2009

(30) Foreign Application Priority Data
Sep. 2, 2008 (JP) 2008-224977
May 20, 2009 (JP) 2009-121890

(51) Int. Cl. H04L 12/54

(52) U.S. Cl. 370/428

(57) ABSTRACT

A storage device is connected to a large-capacity low-speed memory, and divides a packet received via a network into a plurality of segments for storage. The storage device includes a small-capacity high-speed memory. A selector writes the first predetermined number of segments in the packet to the small-capacity high-speed memory, and subsequent segments to the large-capacity low-speed memory. Accordingly, regardless of from what queue a segment is read out in a segment read mode, occurrence of wasteful time in packet transfer can be prevented, and the capacity of the small-capacity high-speed memory can be reduced even when the number of queues increases.

### BACKGROUND OF THE INVENTION

1. Field of the Invention

The present invention relates to a storage device for storing a packet temporarily, employed in a communication terminal such as routers and switches. Particularly, the present invention relates to a storage device capable of accommodating a high-speed network using a large-capacity low-speed memory, and a control approach of the storage device.

2. Description of the Background Art

In recent years, the speed of the network has become higher, leading to the need for communication terminals such as routers and switches to correspond to the fast speed. In general, a communication terminal must temporarily store data in a storage device such as a memory until the destination of transfer is determined. To this end, the data transfer rate of network processors and packet buffers is increased in accordance with the high-speed network, and the need arises for a larger capacity in a memory used as a packet buffer. For example, in the case of a 10 G-bit Ethernet, a network processor with the data transfer rate of 10 Gb/s, and a packet buffer having the data transfer rate of 10 Gb/s and a capacity of 2.5 Gb will be required.

In order to accommodate a high-speed network, a high-speed memory of a large capacity is required. However, since a high-speed memory is costly, technologies are being developed to accommodate a high-speed network by hierarchization of a high speed memory and a low speed memory.

As an example of hierarchized memory control, there is known a method of storing data on a queue-by-queue basis provided in a high speed memory (FIFO (First In First Out)) at the time of writing data, and then transferring the stored data, when accumulated to a predetermined amount, from the queue to a low speed memory in a mass. In a read out mode, data is read out in a mass from the low-speed memory when the amount of data stored in respective queues of the high-speed memory becomes low, and the readout data is transferred to a queue in the high speed memory. Inventions in association with such art are disclosed in Patent Documents 1-4, as set forth below.

The invention disclosed in Document 1 (Japanese Patent Laying-Open No. 2005-117208) is directed to carrying out search of a routing table speedily and economically, corresponding to large scale entries, in a packet transfer apparatus such as an IP router. The upper-stage part of the tree is stored in a first memory whereas the lower-stage part is stored in a second memory. A node at an uppermost stage in the second memory stores address information of nodes on the path of the upper stage part from a node corresponding to a root to the node of the uppermost stage. The upper stage part of the tree is searched on the basis of a destination address to be searched and the uppermost stage node of the lower stage part of the tree is searched on the basis of the search result. When the destination address to be searched is lower than the address of the uppermost stage node, the address information of the nodes on the path of the upper stage part stored in the uppermost node is referenced and the address of the most downstream node that is equal to or lower than the destination address to be searched is determined as the address of a succeeding hop router.

The invention disclosed in Document 2 (Japanese Patent Laying-Open No. 2008-005315) is directed to increasing the speed of communication while suppressing the amount of memory used in network hardware. The host computer of a communication system measures the RTT (Round Trip Time) that is the response time with a destination terminal for every connection at the time of establishing a virtual communication path on the NIC (Network Interface Card). In the case where determination is made that the RTT is larger than a predetermined threshold value, the host computer initiates the storage of the transmission data to the OS retransmission buffer in the host computer, and begins to transfer the transmission data to the NIC. When determination is made that the RTT is smaller than the predetermined threshold value, the host computer initiates transfer of transmission data to the NIC, and begins to store the transferred transmission data into the NIC retransmission buffer in the NIC.

The invention of Document 3 (Japanese Patent Laying-Open No. 2007-060514) provides a routing device that can prevent transfer delay of fixed-rate communication even in the case of burst communication. The cache memory of the routing device is divided into a region for registering fixed rate communication entry and a region for registering communication entry other than fixed-rate communication. Determination is made whether the input data corresponds to fixed-rate communication, and each region is updated individually depending on the determination result. Accordingly, the entry in the region for fixed-rate communication will not be deleted even if burst communication occurs, and fixed-rate communication data can be transferred stably at high speed.

The invention disclosed in Document 4 (Japanese Patent Laying-Open No. 2006-166479) is directed to avoiding delay of retransmission data caused by congestion of a transmission buffer. Medium access control (MAC) architecture reduces the transmission latency for data block retransmission. A plurality of data blocks are received and temporarily stored in a first memory (for example, queue, buffer). Subsequently, the plurality of data blocks are transmitted. Determination is made as to whether reception of each transmitted data block has succeeded, or retransmission is required due to unsuccessful reception of a data block. Each data block that needs to be transmitted again among the transmitted data blocks is marked, and stored in a second memory having a priority higher than that of the first memory. The marked data block is retransmitted before the data block stored in the first memory location is transmitted.

The above-described hierarchized memory control imposes the problem that the system cost is increased since the required size of the high speed memory will become larger according to the number of queues. This problem cannot be overcome even by adapting any of the inventions disclosed in Documents 1-4 set forth above.

In applications for packet buffers employed in network equipment, the amount of data of an externally-applied packet is variable. In order to input/output data at a fixed length, a controller for control thereof is required, leading to the problem that the device becomes costly.

Since the packet buffer employed in network equipment is based on the FIFO scheme, address information is not required if an input packet is simply output in order. However, a plurality of FIFO rows must be provided to set the priority level. With regards to a general packet buffer, a memory for storing the address information and a control circuit for reading out and transferring address information are provided in the controller. Therefore, there was a problem that the device becomes costly.

In the case where the network equipment outputs one input data to a plurality of parts, the input data must be copied before output. This means that the same data must be written a plurality of times into a memory. There was a problem that the time for writing externally-applied data into the memory is reduced. Further, writing the same data a plurality of times into the memory leads to a higher possibility of depletion of an empty region in the memory. Further, access must be gained to the memory for writing address information and the memory for writing the actual data of a packet a plurality of times, leading to higher power consumption.

### SUMMARY OF THE INVENTION

An object of the present invention is to provide a storage device capable of accommodating a high-speed network while reducing the capacity of a high-speed memory.

According to an aspect of the present invention, there is provided a storage device connected to a large-capacity low-speed memory, dividing a packet received via a network into a plurality of segments for storage. The storage device includes a small-capacity high-speed memory, and a selector for writing a first predetermined number of segments in the packet to the small-capacity high-speed memory, and writing a subsequent segment into the large-capacity low-speed memory.

Accordingly, the capacity of the high-speed memory can be reduced even in the case where the number of queues increases.

According to another aspect of the present invention, there is provided a storage device connected to a large-capacity low-speed memory, dividing a packet received via a network into a plurality of segments for storage. The storage device includes a small-capacity high-speed memory, and a selector writing segments in a packet into the large-capacity low-speed memory for every predetermined number of segments, and writing a last odd segment into the small-capacity high-speed memory.

Accordingly, the capacity of the high-speed memory can be reduced even in the case where the number of queues increases.

According to a further aspect of the present invention, there is provided a storage device connected to a large-capacity low-speed memory, dividing a packet received via a network into a plurality of segments for storage. The storage device includes a small-capacity high-speed memory, and a selector for writing, when the number of segments in the packet is greater than or equal to a predetermined number, the predetermined number of segments in the packet into the large-capacity low-speed memory, and then a last odd segment into the large-capacity low-speed memory in a page mode, and when the number of segments in the packet is less than the predetermined number, the packet into the small-capacity high-speed memory.

Accordingly, the capacity of the high-speed memory can be further reduced.

According to still another aspect of the present invention, there is provided a storage device storing data of a packet received via a network into an external memory. A command controller receives a write command and a queue number from a network processor, and controls writing of packet data. An address generator obtains and provides to a memory manager an empty address in a DRAM or SRAM, and updates a value of a pointer corresponding to the queue number received by the command controller for linking to the empty address. The memory manager writes packet data into the DRAM or SRAM according to the empty address output from the address generator.

Accordingly, control by the network processor can be simplified since the network processor has to output only the queue number to the command controller.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram representing a configuration of a general communication terminal accumulating a packet employing a large-capacity low-speed memory.

FIG. 2 represents data of a packet accumulated in a packet buffer (large-capacity low-speed memory) 2 shown in FIG. 1.

FIGS. 3A and 3B are block diagrams representing a configuration of a general communication terminal that accumulates a packet employing a hierarchized memory.

FIG. 4 represents data of a packet accumulated in a small-capacity high-speed memory 3 shown in FIGS. 3A and 3B.

FIG. 5 is a diagram to describe the concept of data transfer for a communication terminal employing a storage device according to a first embodiment of the present invention.

FIG. 6 is a block diagram representing a schematic configuration of a storage device according to the first embodiment.

FIG. 7 is a block diagram to describe in further detail a configuration of a storage device according to the first embodiment.

FIG. 8 is a timing chart to describe an operation of the storage device of the first embodiment in a data write mode.

FIG. 9 is a timing chart to describe an operation of the storage device of the first embodiment in a data read mode.

FIG. 10 represents an example of a communication terminal employing a storage device according to the first embodiment.

FIG. 11 is a diagram to describe the concept of data transfer for a communication terminal employing a storage device according to a second embodiment of the present invention.

FIG. 12 is a block diagram representing a configuration of a storage device 20 according to the second embodiment.

FIG. 13 is a timing chart to describe an operation of a storage device of the second embodiment in a data write mode.

FIG. 14 is a timing chart to describe an operation of a storage device of the second embodiment in a data read mode.

FIG. 15 is a timing chart to describe a data readout operation from a large-capacity low-speed memory 2 by a storage device according to a third embodiment of the present invention.

FIG. 16 is a timing chart to describe an operation of a storage device of the third embodiment in a data write mode.

FIG. 17 is a timing chart to describe an operation of a storage device of the third embodiment in a data read mode.

FIG. 18 is a diagram to describe the basic concept of a storage device according to a fourth embodiment of the present invention.

FIG. 19 a block diagram representing a schematic configuration of the storage device according to the fourth embodiment.

FIG. 20 is a timing chart to describe packet data writing by the storage device of the fourth embodiment.

FIG. 21 is a timing chart to describe packet data reading by the storage device of the fourth embodiment.

FIG. 22 represents correspondence between queues #0 to #n and a memory in which actual packet data is stored.

FIG. 23 is a diagram to describe the basic concept of a storage device according to a fifth embodiment of the present invention.

FIG. 24 is a timing chart to describe packet data writing by the storage device of the fifth embodiment.

FIG. 25 represents correspondence between queues #0 to #n and a memory in which actual multicast packet data is stored.

FIG. 26 is a timing chart to describe packet data writing by a storage device according to a sixth embodiment of the present invention.

### DESCRIPTION OF THE PREFERRED EMBODIMENTS

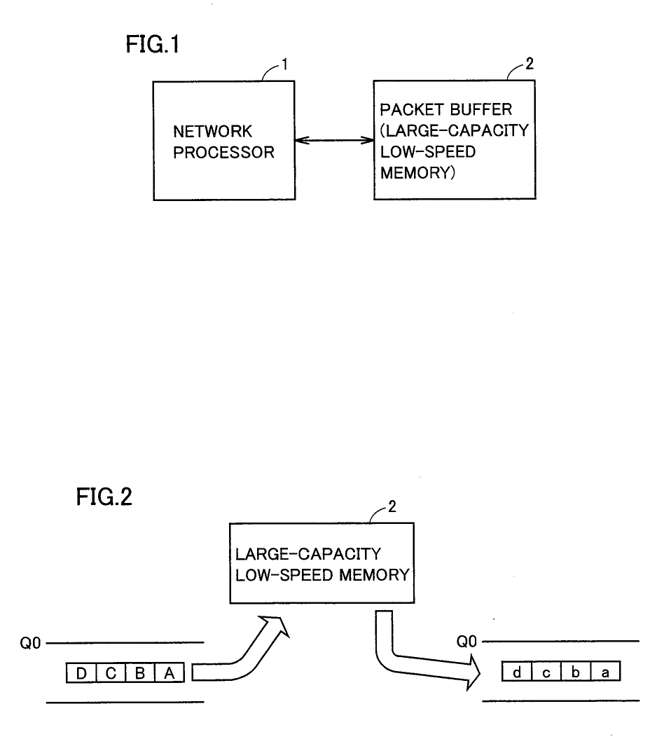

Referring to the block diagram of FIG. 1, a general communication terminal includes a network processor 1, and a packet buffer 2 constituted of a large-capacity low-speed memory.

Referring to FIG. 2, data in a packet (hereinafter, also simply referred to as data) A-D are sequentially accumulated in packet buffer (large-capacity low-speed memory) 2. Upon determination of the packet transfer destination, the accumulated data are read out in order to be provided as data a-d. Since packet buffer 2 in which a packet is accumulated is constituted of only a large-capacity low-speed memory, control for accumulating and reading out a packet on a queue-by-queue basis is often difficult.

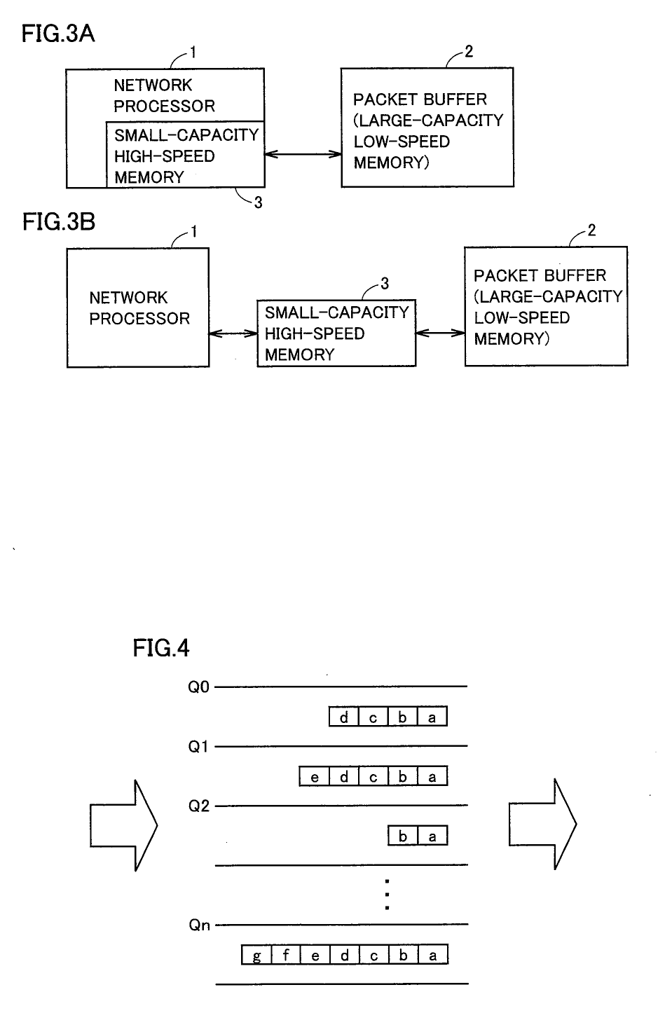

FIGS. 3A and 3B are block diagrams representing examples of a general communication terminal that accumulates a packet employing a hierarchized memory: the former corresponding to a configuration where a small-capacity high-speed memory 3 is incorporated in network processor 1; and the latter corresponding to a configuration where small-capacity high-speed memory 3 is provided between network processor 1 and packet buffer 2.

In the case where the memory is hierarchized, data is accumulated on a queue-by-queue basis provided in small-capacity high-speed memory 3 in a data write mode. When the accumulated data attains a predetermined amount, the data is transferred from the queue in a mass to packet buffer 2. In a data read mode, when the amount of data accumulated in each queue in small-capacity high-speed memory becomes low, data is read out in a mass from packet buffer 2 to be transferred to a queue provided at small-capacity high-speed memory 3.

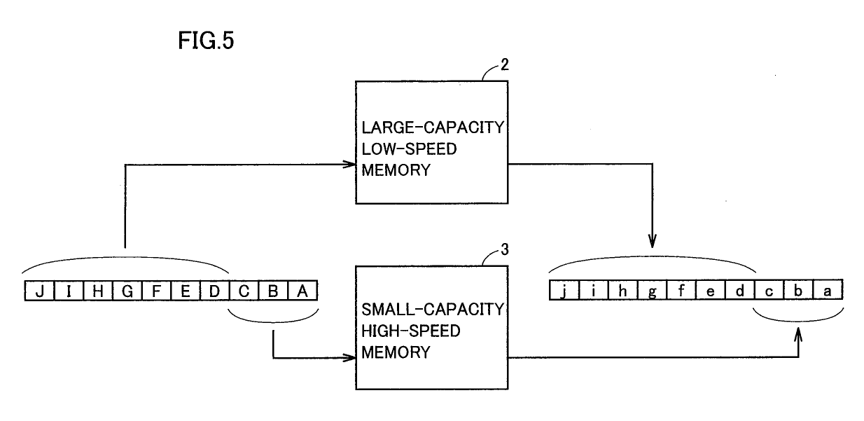

Referring to FIG. 4, data is accumulated in order in queues Q0-Qn, and data is read out in the accumulated order. The reason why the data is assembled for each queue is because the data accumulated in a queue cannot be reversed in order. There is a problem that the capacity of small-capacity high-speed memory 3 will become larger when the number of queues increases.

### First Embodiment

FIG. 5 is a diagram to describe the concept of data transfer for a communication terminal employing a storage device according to a first embodiment of the present invention. In the present embodiment, the first three segments in a packet are written into small-capacity high-speed memory 3 and subsequent segments in that packet are sequentially accumulated in large-capacity low-speed memory 2. As used herein, a “segment” refers to data of an amount corresponding to the data width in small-capacity high-speed memory 3. In FIG. 5, each of “A”, “B”, . . . corresponds to one segment. Since the data length of a packet is variable, one packet is constituted of one or a plurality of segments, depending upon the data length.

In the present embodiment, the first three segments in a packet are written into small-capacity high-speed memory 3, irrespective of the queue number. Accordingly, in a packet read mode, the first three segments will always be read out from small-capacity high-speed memory 3, and concurrently, data of the fourth segment and et seq. is sequentially read out from large-capacity low-speed memory 2. Thus, occurrence of wasteful time between packets can be prevented no matter what queue a packet is read out from.

Although the description is based on the case where the first three segments in a packet are written into high-speed memory 3, the number of segments to be first written is arbitrary and not limited to 3. The number of the first several segments to be written into the high-speed memory depends upon the writing rate (read out rate) of large-capacity low-speed memory 2, as will be readily appreciated from the description set forth below.

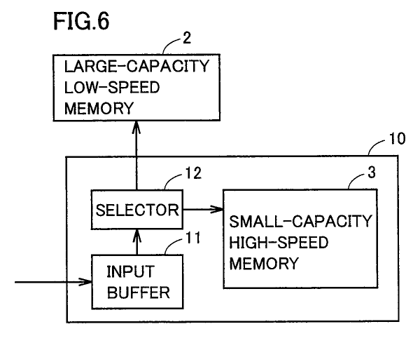

Referring to the block diagram of FIG. 6, a storage device 10 of the first embodiment is connected to large-capacity low-speed memory 2, and includes small-capacity high-speed memory 3, an input buffer 11, and a selector 12.

Input buffer 11 temporarily stores the received data for output to selector 12. Upon receiving data from input buffer 11, selector 12 writes the first three segments in the packet into small-capacity high-speed memory 3, and any subsequent segment in that packet into large-capacity low-speed memory 2. When the number of segments in a packet is equal to or less than 3, writing to small-capacity high-speed memory 3 alone is carried out. Writing to large-capacity low-speed memory 2 is not carried out.

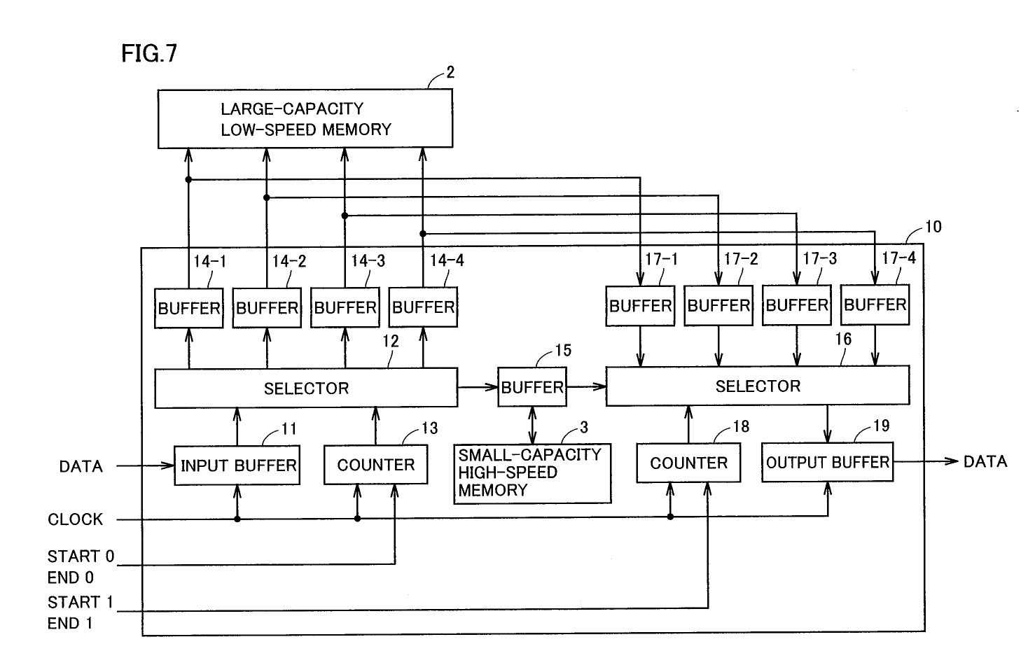

Referring to the block diagram of FIG. 7, storage device 10 is mainly divided into the section for writing data to large-capacity low-speed memory 2 and small-capacity high-speed memory 3 (hereinafter, referred to as a write section), and the section for reading out data from large-capacity low-speed memory 2 and small-capacity high-speed memory 3 for output (hereinafter, referred to as a read section).

The write section includes an input buffer 11, a selector 12, a counter 13, and buffers 14-1 to 14-4. The read section includes a selector 16, buffers 17-1 to 17-4, a counter 18 and an output buffer 19. Buffer 15 is used when data is written from selector 12 into small-capacity high-speed memory 3, and when data is read out from small-capacity high-speed memory 3 to be transferred to selector 16.

The time required for data writing (data reading) in large-capacity low-speed memory 2 is four times that of small-capacity high-speed memory 3. Therefore, large-capacity low-speed memory 2 has a data width four times that of small-capacity high-speed memory 3 in order to write (read) data at a transfer rate identical to that of small-capacity high-speed memory 3. Large-capacity low-speed memory 2 is constituted of 4 memory chips, each carrying out data writing/data reading at respective individual timing.

It is assumed that access control of large-capacity low-speed memory 2 and small-capacity high-speed memory 3 is carried out by network processor 1.

Upon receiving data of a packet from network processor 1, input buffer 11 temporarily stores the received data. Input buffer 11 sequentially provides the data to selector 12 in synchronization with a clock signal.

Upon receiving a signal START0 indicating the beginning of a packet from network processor 1, counter 13 resets and starts count up of the count value in synchronization with the clock signal. Then, counter 13 provides the count value to selector 12. Further, when counter 13 receives a signal END0 indicating the end of a packet from network processor 1, counter 13 notifies selector 12 that the packet has ended.

Selector 12 refers to the count value output from counter 13, and writes the data of the first three segments among the data transferred from input buffer 11 into small-capacity high-speed memory 3 via buffer 15. Selector 12 writes the data of the fourth segment and et seq. into buffers 14-1, 14-2, 14-3 and 14-4 in the cited order. Upon receiving notification of a packet end from counter 13, selector 12 ends data writing at that point of time.

Upon receiving data from selector 12, buffers 14-1 to 14-4 respectively write data into a corresponding memory in large-capacity low-speed memory 2.

Buffers 17-1 to 17-4 respectively read out data from a corresponding memory in large-capacity low-speed memory 2 to output the data to selector 16.

Upon receiving a signal START1 indicating the beginning of a packet from network processor 1, counter 18 resets and starts count up of the count value in synchronization with the clock signal. Counter 18 outputs the count value to selector 16. Upon receiving a signal END1 indicating the end of a packet from network processor 1, counter 18 notifies selector 16 that the packet has ended.

Selector 16 refers to the count value output from counter 18, and reads out data of the first three segments from small-capacity high-speed memory 3 via buffer 15 to provide the data to output buffer 19. Selector 16 reads out data of the fourth segment and et seq. from buffers 17-1, 17-2, 17-3 and 17-4 in the cited order to provide the data to output buffer 19. Selector 16 ends data reading at the point of time of receiving notification of a packet end from counter 18.

Output buffer 19 temporarily stores the data received from selector 16, and sequentially outputs data in synchronization with a clock signal.

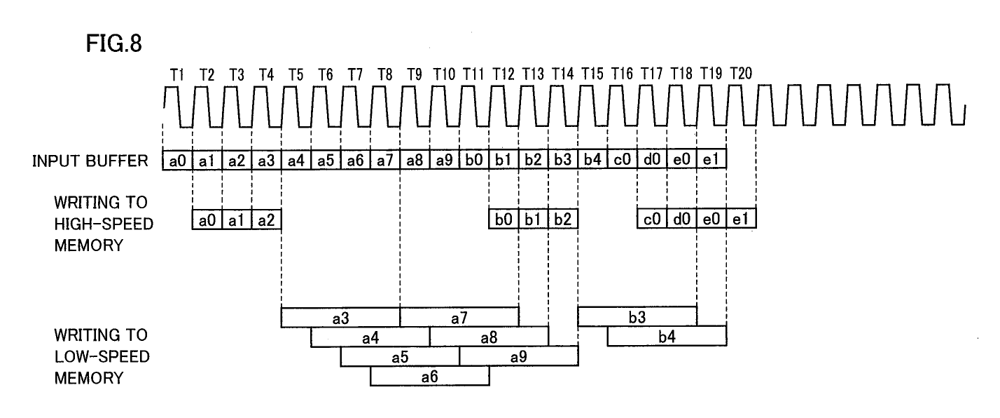

Referring to the timing chart of FIG. 8 corresponding to a data write mode, a0-a9 constitute one packet. Similarly, b0-b4, c0, d0 and e0-e1 each constitute one packet.

At T1, data a0 of the first segment in the first packet output from network processor 1 is stored in input buffer 11. At this stage, counter 13 receives signal START0 from network processor 1 to reset and start count up of the count value.

At T2, data a0 stored in input buffer 11 is written into small-capacity high-speed memory 3 via selector 12 and buffer 15. A similar operation is carried out at T3-T4. Data a0-a2 of three segments are written into small-capacity high-speed memory 3.

At T5, data a3 stored in input buffer 11 is transferred to buffer 14-1 via selector 12. Writing into large-capacity low-speed memory 2 is initiated. This writing of data a3 is carried out in the 4 cycles of T5-T8. Similarly, data a4-a6 are transferred to buffers 14-2 to 14-4, respectively, to be written into large-capacity low-speed memory 2 at respective 4 cycles.

At T9, when writing of data a3 stored in buffer 14-1 into large-capacity low-speed memory 2 has ended, data a7 stored in input buffer 11 is transferred to buffer 14-1 via selector 12, and writing into large-capacity low-speed memory 2 is initiated. This writing of data a7 is carried out in the 4 cycles of T9-T12. In a similar manner, data a8-a9 are transferred to buffers 14-2 to 14-3, respectively, and written into large-capacity low-speed memory 2 at respective 4 cycles.

At T10, counter 13 receives signal END0 from network processor 1 to notify selector 12 that the packet has ended. At T11, data b0 of the next packet output from network processor 1 is stored in input buffer 11. At this stage, counter 13 receives signal START0 from network processor 1 to reset and start count up of the count value.

At T12, data b0 stored in input buffer 11 is written into small-capacity high-speed memory 3 via selector 12 and buffer 15. A similar operation is carried out at T13-T14, and data b0-b2 of 3 segments are written into small-capacity high-speed memory 3.

At T15, data b3 stored in input buffer 11 is transferred to buffer 14-1 via selector 12, and writing to large-capacity low-speed memory 2 is initiated. This writing of data b3 is carried out in the 4 cycles of T15-T18. Similarly, data b4 is transferred to buffer 14-2 and written into large-capacity low-speed memory 2 in 4 cycles.

At T17-T20, data c0, d0 and e0-e1 of 3 packets are sequentially written into small-capacity high-speed memory 3.

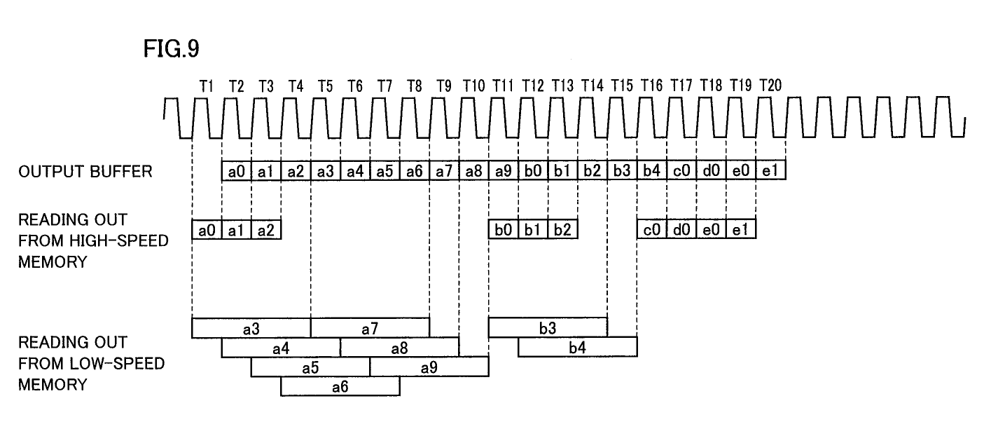

Referring to the timing chart of FIG. 9 corresponding to a data read out mode, a0-a9 constitute one packet. Similarly, b0-b4, c0, d0 and e0-e1 each constitute one packet.

At T1, counter 18 receives signal START1 from network processor 1 to reset and start count up of the count value. At this stage, selector 16 reads out data a0 of the first segment in the first packet from small-capacity high-speed memory 3 via buffer 15. Buffer 17-1 initiates read out of data a3 from large-capacity low-speed memory 2.

At T2, selector 16 writes data a0 read out from small-capacity high-speed memory 3 to output buffer 19. At T3-T4, a similar operation is carried out. Data a0-a2 of 3 segments are written into output buffer 19.

At T5, reading of data a3 from large-capacity low-speed memory 2 has ended, allowing selector 16 to read out data a3 stored in buffer 17-1 to write the read data to output buffer 19. At this cycle, reading data a7 out from large-capacity low-speed memory 2 is initiated. A similar operation is carried out at T6-T11. Data a4-a9 are sequentially written into output buffer 19.

At T10, counter 18 receives signal END1 from network processor 1 to notify selector 16 that the packet has ended. At T11, counter 18 receives signal START1 from network processor 1 to reset and initiate count up of the count value. At this stage, selector 16 reads out data b0 of the first segment in the second packet from small-capacity high-speed memory 3 via buffer 15. Buffer 17-1 initiates reading data b3 out from large-capacity low-speed memory 2.

At T12, selector 16 writes data b0 read out from small-capacity high-speed memory 3 into output buffer 19. At T13-T14, a similar operation is carried out. Data b0-b2 of 3 segments are written into output buffer 19.

At T15, reading of data b3 out from large-capacity low-speed memory 2 has ended, allowing selector 16 to read out data b3 stored in buffer 17-1 and write the read data to output buffer 19. At T16, a similar operation is carried out. Data b4 is written to output buffer 19.

At T16-T19, data c0, d0 and e0-e1 of 3 packets are sequentially read out from small-capacity high-speed memory 3 to be sequentially written into output buffer 19.

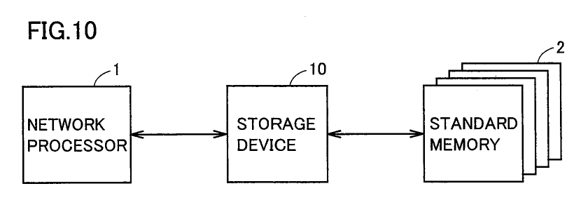

FIG. 10 represents an example of a communication terminal employing a storage device of the first embodiment. Storage device 10 of the present embodiment is provided between network processor 1 and a standard memory (large-capacity low-speed memory) 2 to carry out the operation set forth above. As the standard memory, a DRAM (Dynamic Random Access Memory) may be used. However, the present invention is not particularly limited to a DRAM, and any device that allows writing of a large amount as compared to small-capacity high-speed memory 3 can be used.

According to storage device 10 of the present embodiment, the first several segments in a packet are written into small-capacity high-speed memory 3, irrespective of the queue number, and subsequent segments are written into large-capacity low-speed memory 2. Therefore, occurrence of wasteful time for packet transfer can be prevented no matter what queue data is read out from in a data read mode.

Further, since the first several segments in a packet are stored in small-capacity high-speed memory 3, irrespective of the queue number, packet transfer can be performed at high speed without increase in the capacity of the high-speed memory. Moreover, increase in the capacity of the high speed memory in accordance with increase of the number of queues can be prevented. Therefore, the entire cost of the system can be reduced.

In a data read out mode, data is directly read out from large-capacity low-speed memory 2 and small-capacity high-speed memory 3 without having to transfer the data written in large-capacity low-speed memory 2 to small-capacity high-speed memory 3, or transferring the data written into small-capacity high-speed memory 3 to large-capacity low-speed memory 2. Therefore, the entire power consumption of the system can be reduced.

Further, the latency in reading can be shortened since the first segment in a packet is read out from small-capacity high-speed memory 3.

Moreover, the access control towards the memory can be simplified since the first several segments in a packet are written into small-capacity high-speed memory 3, and the subsequent segments are written into large-capacity low-speed memory 2. Similarly in reading out data from large-capacity low-speed memory 2 and small-capacity high-speed memory 3, the access control towards the memory can be simplified.

### Second Embodiment

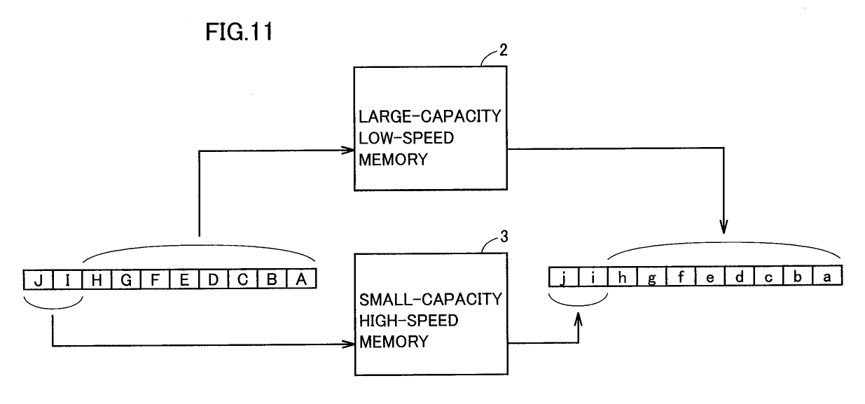

FIG. 11 is a diagram to describe the concept of data transfer for a communication terminal employing a storage device according to a second embodiment of the present invention. In the present embodiment, when the first four segments in a packet are available, the data of the four segments are written into large-capacity low-speed memory 2. A similar operation is carried out every time a set of 4 segments is available. The remaining odd segments in a packet (any of segments less than 4) are written into small-capacity high-speed memory 3. In the example of FIG. 11, the first eight segments A to H in a packet are written into large-capacity low-speed memory 2, and segments I and J that are the remaining odd segments in the packet are written into small-capacity high-speed memory 3.

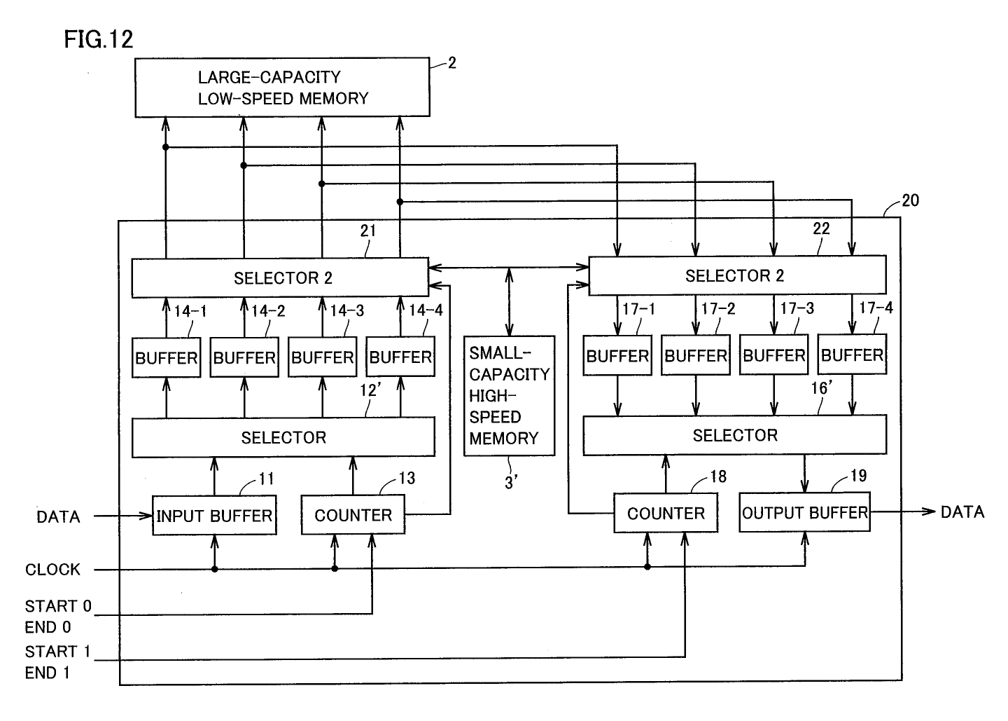

FIG. 12 is a block diagram representing a configuration of a storage device 20 of the second embodiment. The storage device of the second embodiment differs from the storage device of the first embodiment shown in FIG. 7 in the configuration of small-capacity high-speed memory 3, the function of selectors 12 and 16, and the addition of a selector 2 (21, 22). Description of similar configurations and functions will not be repeated. In the description of the present embodiment, the small-capacity high-speed memory will take the reference number 3′, and the selectors will take the reference numbers 12′ and 16′.

Since three segments at most must be written simultaneously, small-capacity high-speed memory 3′ has a data width three times the data width of small-capacity high-speed memory 3 of the first embodiment. In the present embodiment, it is assumed that small-capacity high-speed memory 3′ is constituted of three memory chips.

Buffers 14-1 to 14-4 each have a capacity to store data of at least two segments. When data is read out from one region, data can be written into the other region.

Selector 12′ refers to the count value output from counter 13 to write the data transferred from input buffer 11 into buffers 14-1, 14-2, 14-3 and 14-4 in the cited order. A similar operation is carried out thereafter.

Selector 2 (21) refers to the count value output from counter 13, and writes data of 4 segments, at the point of time when the data of 4 segments have been stored in buffers 14-1 to 14-4, to large-capacity low-speed memory 2. In addition, upon receiving notification of a packet end from counter 13, selector 2 (21) refers to the count value output from counter 13, and writes data of odd segments stored in buffers 14-1 to 14-4 at that point of time to small-capacity high-speed memory 3′.

Upon receiving notification of a packet beginning from counter 18, selector 2 (22) reads out the data of 4 segments from large-capacity low-speed memory 2 to write each data to buffers 17-1 to 17-4, respectively. In addition, selector 2 (22) refers to the count value output from counter 13 to read out the data of 4 segments from large-capacity low-speed memory 2 at the point of time when data transfer of the next 4 segments is required, and writes the read data to buffers 17-1 to 17-4. Upon receiving notification of a packet end from counter 18, selector 2 (22) refers to the count value output from counter 13, and reads out any odd segments from small-capacity high-speed memory 3′ to write the read data into a corresponding buffer among buffers 17-1 to 17-3.

Selector 16′ refers to the count value output from counter 18, and selectively provides the data output from buffers 17-1 to 17-4 to output buffer 19.

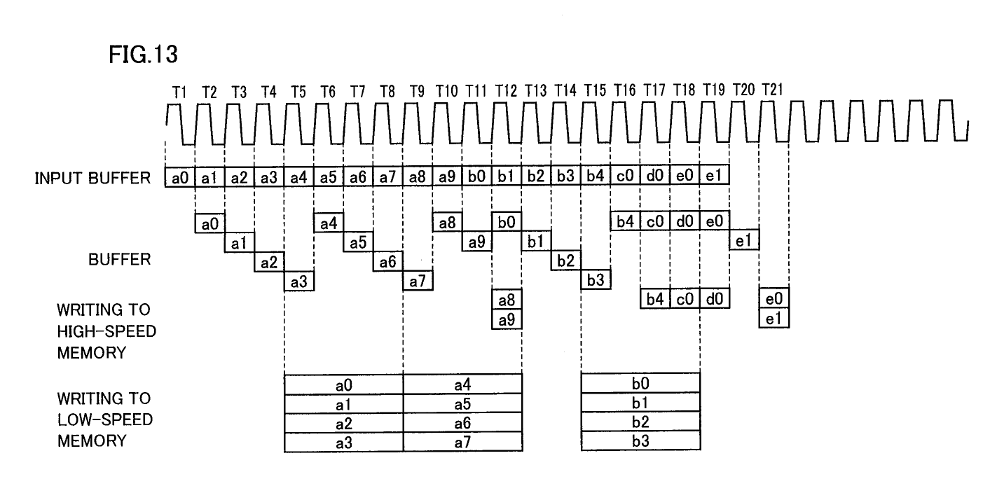

FIG. 13 is a timing chart to describe the operation of the storage device of the second embodiment in a data write mode. In FIG. 13, a0-a9 constitute one packet. Similarly, b0-b4, c0, d0 and e0-e1 each constitute one packet.

At T1, data a0 of the first segment in the first packet output from network processor 1 is stored in input buffer 11. At this point of time, counter 13 receives signal START0 from network processor 1 to reset and initiate count up of the count value.

At T2, data a0 stored in input buffer 11 is written to buffer 14-1 via selector 12′. At T3-T5, a similar operation is carried out. Data a0-a3 of 4 segments are sequentially written into buffers 14-1 to 14-4.

At T5, selector 2 (21) initiates writing of data a0-a3 stored in buffers 14-1 to 14-4 to large-capacity low-speed memory 2. This writing of data a0-a3 is carried out in the 4 cycles of T5-T8.

At T6, data a4 stored in input buffer 11 is written into buffer 14-1 via selector 12′. At T7-T9, a similar operation is carried out. Data a4-a7 of 4 segments are sequentially written into buffers 14-1 to 14-4.

At T9, selector 2 (21) initiates writing of data a4-a7 stored in buffers 14-1 to 14-4 into large-capacity low-speed memory 2. This writing of data a4-a7 is carried out in the 4 cycles of T9-T12.

At T10, data a8 stored in input buffer 11 is written into buffer 14-1 via selector 12′. At T11, a similar operation is carried out. When data a8-a9 of 2 segments are written into buffers 14-1 to 14-2, a signal END0 is output from network processor 1.

At T12, selector 2 (21) writes data a8-a9 stored in buffers 14-1 to 14-2 to small-capacity high-speed memory 3′. At T12, data b0 stored in input buffer 11 is written into buffer 14-1 via selector 12′. At T13-T15, a similar operation is carried out. Data b0-b3 of 4 segments are sequentially written into buffers 14-1 to 14-4.

At T15, selector 2 (21) initiates writing of data b0-b3 stored in buffers 14-1 to 14-4 to large-capacity low-speed memory 2. This writing of data b0-b3 is carried out in the 4 cycles of T15-T18.

At T16, when data b4 stored in input buffer 11 is written into buffer 14-1 via selector 12′, a signal END0 is output from network processor 1.

At T17, selector 2 (21) writes data b4 stored in buffer 14-1 to small-capacity high-speed memory 3′.

At T18-T19, a similar operation is carried out. Selector 2 (21) writes data c0 and d0 into small-capacity high-speed memory 3′.

At T19, data e0 stored in input buffer 11 is written into buffer 14-1 via selector 12′. At T20, a similar operation is carried out. When data e0-e1 of two segments are written into buffers 14-1 to 14-2, a signal END0 is output from network processor 1.

At T21, selector 2 (21) writes data e0-e1 stored in buffers 14-1 to 14-2 to small-capacity high-speed memory 3′.

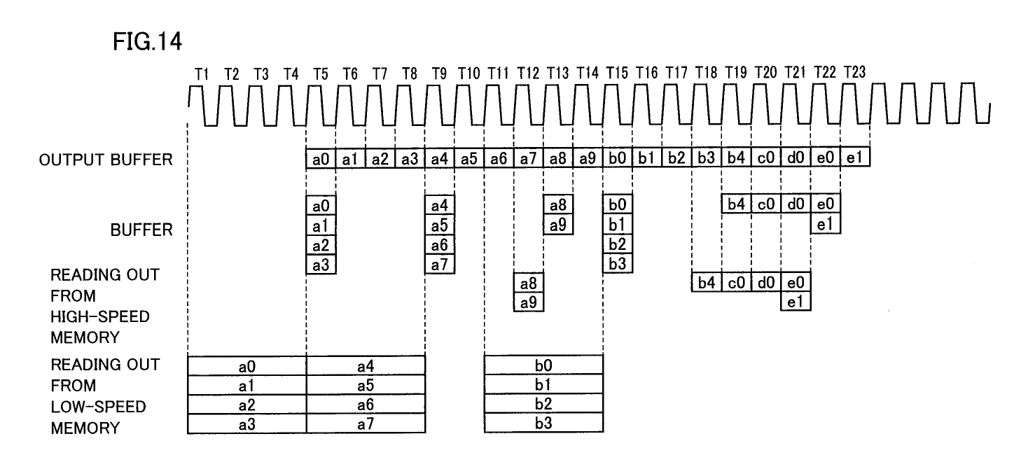

FIG. 14 is a timing chart to describe an operation of the storage device of the second embodiment in a data read mode. In FIG. 14, a0-a9 constitute one packet. Similarly, b0-b4, c0, d0 and e0-e1 each constitute one packet.

At T1, counter 18 receives signal START1 from network processor 1 to reset and initiate count up of the count value. At this stage, reading out data a0-a3 of the 4 segments in the first packet stored in large-capacity low-speed memory 4 is initiated.

At T5, selector 2 (22) writes data a0-a3 read out from large-capacity low-speed memory 2 to buffers 17-1 to 17-4. At this stage, selector 16′ transfers data a0 stored in buffer 17-1 to output buffer 19. Further, selector 2 (22) initiates reading out of data a4-a7 stored in large-capacity low-speed memory 2.

At T6-T8, selector 16′ transfers data a1-a3 stored in buffers 17-2 to 17-4 sequentially to output buffer 19.

At T9, selector 2 (22) writes data a4-a7 read out from large-capacity low-speed memory 2 to buffers 17-1 to 17-4, respectively. At this stage, selector 16′ transfers data a4 stored in buffer 17-1 to output buffer 19.

At T10-T12, selector 16′ sequentially transfers data a5-a7 stored in buffers 17-2 to 17-4 to output buffer 19. At T10, counter 18 receives signal END1 from network processor 1 to notify selector 16′ and selector 2 (22) that the packet has ended.

At T11, counter 18 receives signal START1 from network processor 1 to reset and initiate count up of the count value. At this stage, reading out data b0-b3 of the 4 segments in the next packet stored in large-capacity low-speed memory 2 is initiated.

At T12, selector 2 (22) reads out odd data a8 and a9 from small-capacity high-speed memory 3′ and writes the odd data into buffers 17-1 and 17-2, respectively. At T13, selector 16′ transfers data a8 stored in buffer 17-1 to output buffer 19. At T14, selector 16′ transfers data a9 stored in buffer 17-2 to output buffer 19.

At T15, selector 2 (22) writes data b0-b3 read out from large-capacity low-speed memory 2 to buffers 17-1 to 17-4, respectively. At this stage, selector 16′ transfers data b0 stored in buffer 17-1 to output buffer 19.

At T16-T18, selector 16′ transfers data b1-b3 stored in buffers 17-2 to 17-4 sequentially to output buffer 19. At T16, counter 18 receives signal END1 from network processor 1 to notify selector 16′ and selector 2 (22) that the packet has ended.

At T18, selector 2 (22) reads out odd data b4 from small-capacity high-speed memory 3′ to write the odd data into buffer 17-1. At T19, selector 16′ transfers data b4 stored in buffer 17-1 to output buffer 19.

At T20-T23, a similar operation is carried out. Selector 16′ transfers data c0, d0, and e0-e1 sequentially to output buffer 19.

According to storage device 20 of the second embodiment, every four segments in a packet are written into large-capacity low-speed memory 2, and the last odd segments remaining in the packet are written into small-capacity high-speed memory 3′, irrespective of the queue number. Therefore, advantages similar to those described in the first embodiment can be offered.

### Third Embodiment

A storage device according to a third embodiment of the present invention differs from storage device 20 of the second embodiment in that a page mode for large-capacity low-speed memory 2 is employed. For those having segments more than 4 in a packet, the data of the fifth segment and et seq. (including any odd segment) are written into large-capacity low-speed memory 2 in a page mode. For those having 3 or fewer segments in a packet, the data are written into small-capacity high-speed memory 3′.

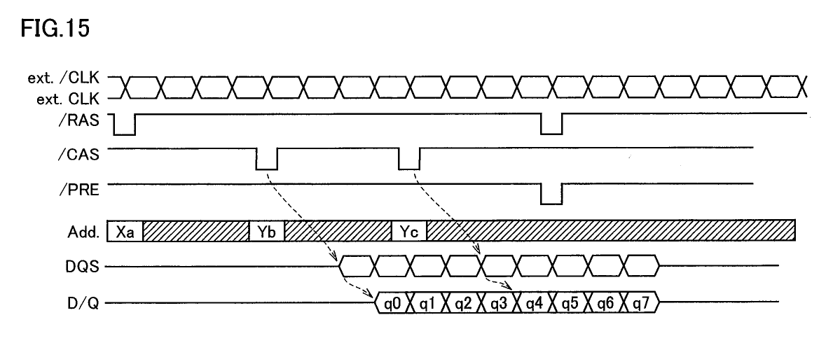

FIG. 15 is a timing chart to describe a data read out operation from large-capacity low-speed memory 2 by the storage device of the third embodiment. In the drawing, the “/” sign added in front of a signal designation implies an active low.

Referring to FIG. 15, when signal /RAS attains a low level (hereinafter, abbreviated as “L level”), a row address “Xa” is input. When signal /CAS attains an L level, column address “Yb” is input, followed by input of a signal DQS in synchronization with a clock signal (ext./CLK, ext.CLK), whereby data is output to signals D/Q.

The timing chart of FIG. 15 corresponds to the case where data q0-q3 of 4 segments corresponding to column address “Yb” are read out at high speed and data q4-q7 of 4 segments corresponding to column address “Yc” are read out at high speed. When the second row address is input, precharging (/PRE) is carried out. The DRAM control signals shown in FIG. 15 are generated by network processor 1.

The storage device of the third embodiment differs from the storage device of the second embodiment shown in FIG. 12 only in the function of selector 2 (21) and selector 2 (22). Therefore, description of similar configurations and functions will not be repeated. In the present embodiment, selector 2 will take the reference numbers 21′ and 22′.

Buffers 14-1 to 14-4 each have a capacity to store data of at least 2 segments. When data is read out from one region, data can be written into another region.

Similarly, buffers 17-1 to 17-4 each have a capacity to store data of at least 2 segments. When data is read out from one region, data can be written into another region.

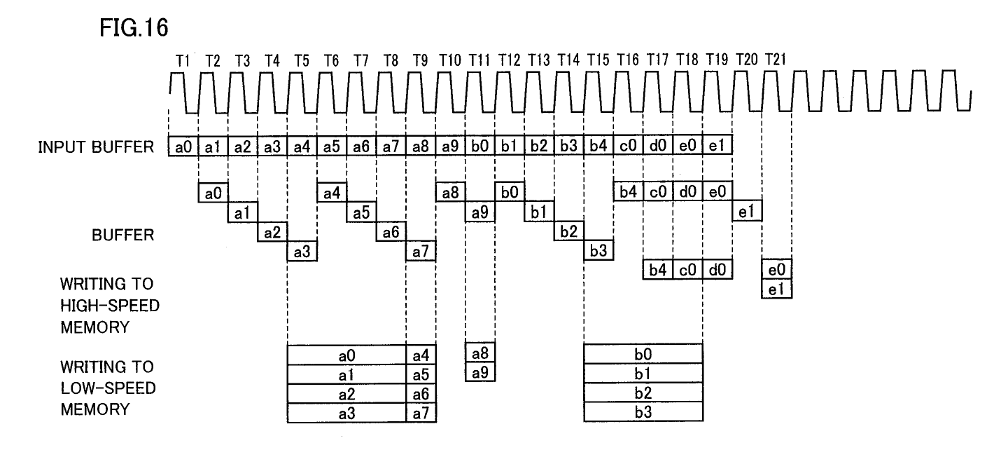

FIG. 16 is a timing chart to describe an operation of the storage device of the third embodiment in a data write mode. In FIG. 16, a0-a9 constitute one packet. Similarly, b0-b4, c0, d0 and e0-e1 each constitute one packet.

At T1, data a0 of the first segment in the first packet output from network processor 1 is stored in input buffer 11. At this point of time, counter 13 receives signal START0 from network processor 1 to reset and initiate count up of the count value.

At T2, data a0 stored in input buffer 11 is written to buffer 14-1 via selector 12′. At T3-T5, a similar operation is carried out. Data a0-a3 of 4 segments are sequentially written into buffers 14-1 to 14-4, respectively.

At T5, selector 2 (21) initiates writing of data a0-a3 stored in buffers 14-1 to 14-4 into large-capacity low-speed memory 2. This writing of data a0-a3 is carried out in the 4 cycles of T5-T8.

At T6, data a4 stored in input buffer 11 is written into buffer 14-1 via selector 12′. At T7-T9, a similar operation is carried out. Data a4-a7 of 4 segments are sequentially written into buffers 14-1 to 14-4.

At T9, selector 2 (21) writes data a4-a7 stored in buffers 14-1 to 14-4 to large-capacity low-speed memory 2 in a page mode. This writing of data a4-a7 is completed in one cycle.

At T10, data a8 stored in input buffer 11 is written into buffer 14-1 via selector 12′. At T11, a similar operation is carried out. When data a8-a9 of 2 segments are written into buffers 14-1 to 14-2, signal END0 is output from network processor 1. At this stage, selector 2 (21) writes data a8-a9 stored in buffers 14-1 to 14-2 to small-capacity high-speed memory 3′ in a page mode.

At T12, data b0 stored in input buffer 11 is written into buffer 14-1 via selector 12′. At T13-T15, a similar operation is carried out. Data b0-b3 of 4 segments are sequentially written into buffers 14-1 to 14-4.

At T15, selector 2 (21) initiates writing of data b0-b3 stored in buffers 14-1 to 14-4 to large-capacity low-speed memory 2. This writing of data b0-b3 is carried out in the 4 cycles of T15-T18.

At T16, when data b4 stored in input buffer 11 is written into buffer 14-1 via selector 12′, signal END0 is output from network processor 1.

At T17, selector 2 (21) writes data b4 stored in buffer 14-1 to small-capacity high-speed memory 3′.

At T18-T19, a similar operation is carried out. Selector 2 (21) writes data c0 and d0 into small-capacity high-speed memory 3′.

At T19, data e0 stored in input buffer 11 is written into buffer 14-1 via selector 12′. At T20, a similar operation is carried out. When data e0-e1 of two segments are written to buffers 14-1 to 14-2, signal END0 is output from network processor 1.

At T21, selector 2 (21) writes data e0-e1 stored in buffers 14-1 to 14-2 to small-capacity high-speed memory 3′.

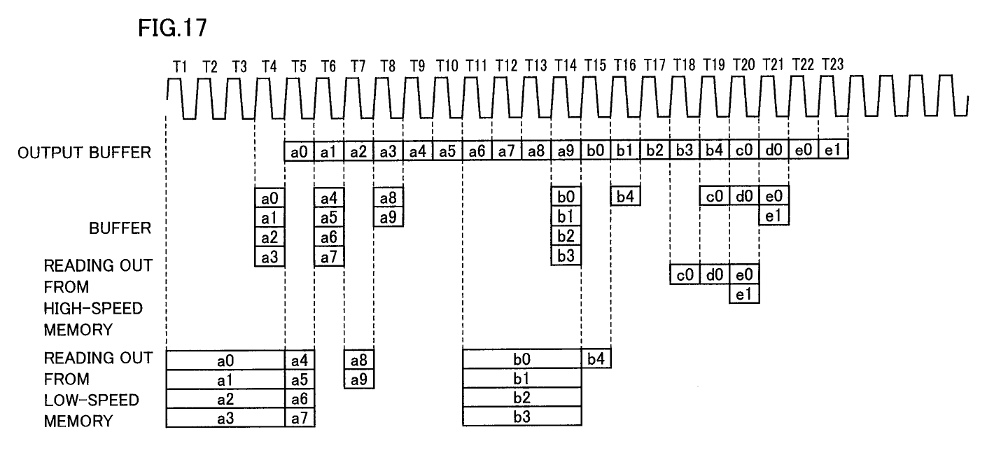

FIG. 17 is a timing chart to describe a data read out operation by the storage device of the third embodiment. In FIG. 17, a0-a9 constitute one packet. Similarly, b0-b4, c0, d0 and e0-e1 each constitute one packet.

At T1, counter 18 receives signal START1 from network processor 1 to reset and initiate count up of the count value. At this stage, reading out data a0-a3 of the 4 segments in the first packet stored in large-capacity low-speed memory 2 is initiated.

At T4, selector 2 (22) writes data a0-a3 read out from large-capacity low-speed memory 2 into buffers 17-1 to 17-4, respectively.

At T5, selector 2 (22) reads out data a4-a7 stored in large-capacity low-speed memory 2 in a page mode. This read out of data a4-a7 is completed in one cycle. At T6, selector 2 (22) writes data a4-a7 read out from large-capacity low-speed memory 2 to buffers 17-1 to 17-4, respectively.

At T5-T8, selector 16′ transfers data a0-a3 stored in buffers 17-1 to 17-4 sequentially to output buffer 19.

At T7, selector 2 (22) reads out odd data a8-a9 stored in large-capacity low-speed memory 2 in a page mode. At T8, selector 2 (22) writes data a8-a9 read out from large-capacity low-speed memory 2 to buffers 17-1 to 17-2, respectively.

At T9-T12, selector 16′ transfers data a4-a7 stored in buffers 17-1 to 17-4 sequentially to output buffer 19.

At T11, counter 18 receives signal START1 from network processor 1 to reset and initiate count up of a count value. At this stage, reading out data b0-b3 of the 4 segments in the next packet stored in large-capacity low-speed memory 2 is initiated.

At T13-T14, selector 16′ transfers odd data a8 and a9 stored in buffers 17-1 to 17-2 to output buffer 19.

At T14, selector 2 (22) writes data b0-b3 read out from large-capacity low-speed memory 2 to buffers 17-1 to 17-4, respectively.

At T15-T18, selector 16′ transfers data b0-b3 stored in buffers 17-1 to 17-4 sequentially to output buffer 19. At T15, selector 2 (22) reads out odd data b4 from large-capacity low-speed memory 2 in a page mode and writes the read data to buffer 17-1. At T19, selector 16′ transfers data b4 stored in buffer 17-1 to output buffer 19.

At T18-T20, selector 2 (22) reads out data c0, d0 and e0-e1 from small-capacity high-speed memory 3′ to sequentially write the data to buffers 17-1 to 17-2. At T20-23, selector 16′ transfers data c0, d0 and e0-e1 sequentially to output buffer 19.

According to storage device 20 of the third embodiment, those having more than 4 segments in a packet are written, together with any odd segment, into large-capacity low-speed memory 2 in page mode. Therefore, the capacity of small-capacity high-speed memory 3′ can be further reduced as compared to the storage device of the second embodiment.

### Fourth Embodiment

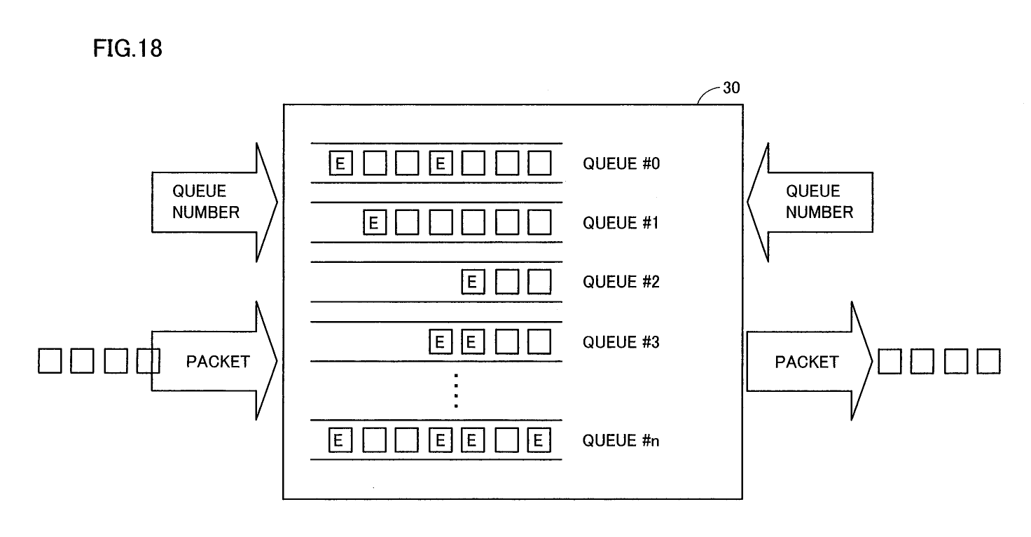

FIG. 18 is a diagram to describe the basic concept of a storage device according to a fourth embodiment. When packet data is to be input, storage device 30 receives only externally-applied packet data and a queue number for storing the subject data, and stores the data in the corresponding queue. When packet data is to be output, storage device 30 receives only an externally-applied queue number, and reads out packet data from the queue corresponding to the queue number for output to an external source.

In FIG. 18, one square in each queue represents one segment. For example, two packets are stored in queue #0. The four segments from the right constitute one packet, and the three following segments constitute one packet. The fourth and seventh segments from the right with “E” implies that it is the last segment in one packet.

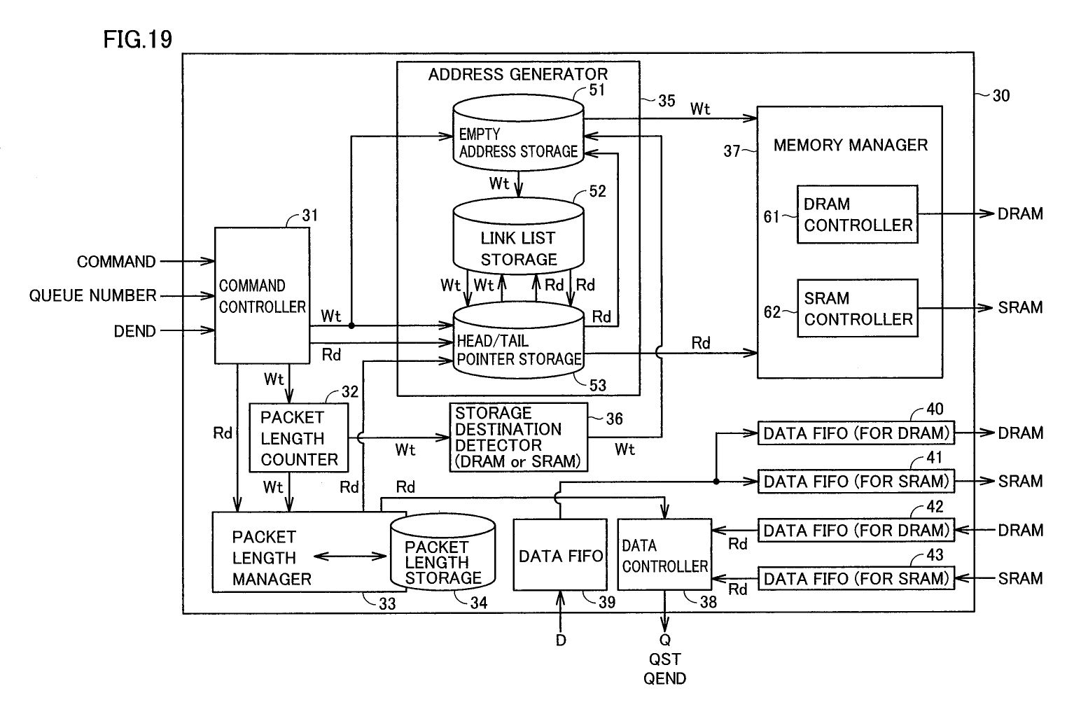

FIG. 19 is a block diagram representing a schematic configuration of a storage device according to the fourth embodiment. Storage device 30 is connected to a large-capacity low-speed memory (DRAM), and a small-capacity high-speed memory (SRAM) not shown, and includes a command controller 31, a packet length counter 32, a packet length manager 33, a packet length storage 34, an address generator 35, a storage destination detector 36, a memory manager 37, a data controller 38, and data FIFOs 39-43. The actual packet data is stored in a DRAM or SRAM not shown. Address generator 35 has queue capability.

Address generator 35 includes an empty address storage 51, a link list storage 52, and a head/tail pointer storage 53. Empty address storage 51 stores an empty address where actual data is not stored among the addresses in the DRAM and SRAM.

Head/tail pointer storage 53 stores the head pointer and tail pointer corresponding to each of queues #0 to #n. The head pointer corresponds to information indicating what number segment in the corresponding queue is the head segment. The tail pointer represents information indicating what number segment in the corresponding queue is the last segment. Therefore, the head pointer is updated when data is read out from a queue. Further, the tail pointer is updated when data is written into a queue.

Link list storage 52 stores the address of the DRAM or SRAM where actual data is stored, corresponding to each segment in each queue, i.e. a link list.

Memory manager 37 includes a DRAM controller 61 and an SRAM controller 62. DRAM controller 61 controls the access to the DRAM according to an address output from address generator 35. SRAM controller 62 controls the access to the SRAM according to an address output from address generator 35.

Command controller 31 receives a command and a queue number from network processor 1 to carry out control corresponding to the command. A signal DEND applied to command controller 31 serves to notify the end of packet data when data of a packet is written into a queue.

<Packet Data Writing>

When a packet write command and a queue number are received from network processor 1, command controller 31 notifies packet length counter 32, address generator 35 and data FIFO 39 of reception of a write command.

Data FIFO 39 initiates input of data (D) with a predetermined latency. At this stage, packet length counter 32 initiates counting of the number of data input to data FIFO 39.

Storage destination detector 36 referring to the value of packet length counter 32 instructs address generator 35 to generate a data storage destination address upon detecting that the value of packet length counter 32 has been updated and packet data has been input.

Address generator 35 reads out the value of the tail pointer corresponding to the queue number stored in head/tail pointer storage 53, and refers to link list storage 52 to obtain the address in the DRAM or SRAM where a segment corresponding to the tail pointer is stored. Then, access is made to empty address storage 51 to determine whether the address next to that address is empty or not. If the address is empty, that identified address is output from empty address storage 51. If that address is not empty, empty address storage 51 is made to output an empty address in DRAM or SRAM upon access to empty address storage 51.

DRAM controller 61 or SRAM controller 62 carries out data writing to a DRAM or SRAM corresponding to the address output from address generator 35. At this stage, the data stored in data FIFO 39 is sequentially transferred to data FIFO 40 or data FIFO 41 to be output to a DRAM or SRAM.

Address generator 35 responds to data writing to a DRAM or SRAM to update the value of the tail pointer stored in head/tail pointer storage 53, and links the address of the DRAM or SRAM in which data was written to the value of the tail pointer to update link list storage 52.

By repeating the process set forth above, packet data is sequentially stored into a DRAM or SRAM. Upon sensing that packet data writing has ended by signal DEND, command controller 31 notifies packet length counter 32 and data FIFO 39 of the same accordingly. Packet length counter 32 notifies packet length manager 33 of the packet length of the written packet.

Packet length manager 33 stores the packet length received from packet length counter 32 into packet length storage 34 to govern the packet length for each packet stored in each queue.

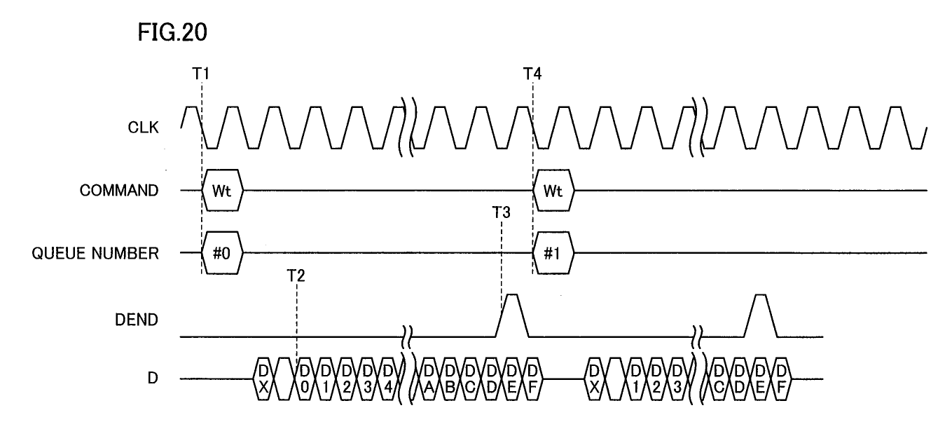

FIG. 20 is a timing chart to describe a packet data writing operation in a storage device according to the fourth embodiment. At T1, command controller 31 initiates writing of packet data upon receiving a write command (Wt) and a queue number (#0) from network processor 1.

When effective data is input at T2 and et seq., data FIFO 39 stores packet data (D0-DF) which is sequentially output to a DRAM or SRAM via data FIFO 40 or FIFO or 41.

When command controller 31 receives signal DEND at T3, packet length counter 32 and data FIFO 39 are notified that packet data writing has ended. Packet length manager 33 stores the packet length received from packet length counter 32 into packet length storage 34.

At T4, when command controller 31 receives a write command (Wt) and a queue number (#1) from network processor 1, packet data writing is initiated. Thereafter, a similar process is carried out.

<Packet Data Reading>

Upon receiving a packet read command and a queue number from network processor 1, command controller 31 notifies packet length manager 33 and address generator 35 of reception of a read command.

Packet length manager 33 gains access to head/tail pointer storage 53 to read out the value from the head pointer corresponding to the queue number, and obtains the packet length of that packet from packet length storage 34.

Address generator 35 gains access to head/tail pointer storage 53 to read out the value from the head pointer corresponding to the queue number, and gains access to link list storage 52 to provide to memory manager 37 the storage destination address of the segment corresponding to the value of the head pointer.

DRAM controller 61 or SRAM controller 62 reads out data from a DRAM or SRAM according to the address output from address generator 35. The data read out from the DRAM or SRAM is sequentially stored in data FIFO 42 or data FIFO 43.

At this stage, address generator 35 updates the value of the head pointer, and also gains access to link list storage 52 to provide the address corresponding to the next segment to memory manager 37. The address from which data was read out is added to empty address storage 51 as an empty address so that it is can be used in the next data writing.

Data controller 38 reads out the data stored in data FIFO 42 or data FIFO 43 to sequentially output the read data to network processor 1. Signal Q output from data controller 38 implies packet data. Signal QST represents the start of packet data output. Further, signal QEND represents the end of packet data output.

Address generator 35, memory manager 37 and data controller 38 repeat the process set forth above corresponding to the packet length obtained by packet length manager 33 to output data of one packet towards network processor 1.

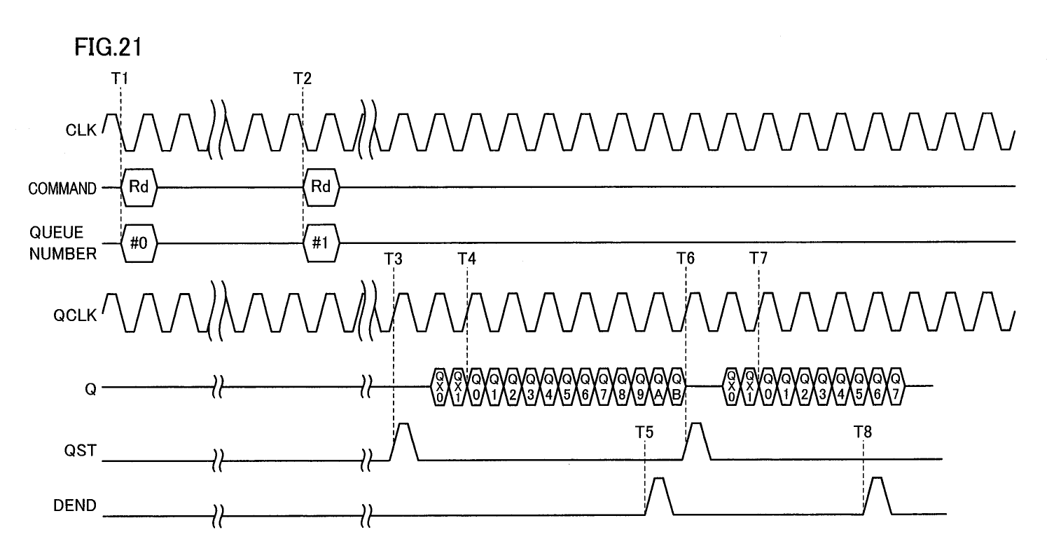

FIG. 21 is a timing chart to describe a packet data reading operation in the storage device according to the fourth embodiment. At T1, command controller 31 initiates reading out of packet data upon receiving a read command (Rd) and a queue number (#0) from network processor 1.

At T2, command controller 31 receives the next read command (Rd) and queue number (#1) from network processor 1. The relevant process is carried out after the process of the first read command has ended.

At T3, data controller 38 outputs a signal QST to notify network processor 1 of initiation of read data output corresponding to queue #0. At T4 and et seq., data controller 38 outputs effective data (Q0-QB) stored in data FIFO 42 or data FIFO 43 to network processor 1.

At T5, data controller 38 outputs a signal QEND to notify network processor 1 of the end of read data output.

At T6, data controller 38 outputs a signal QST to notify network processor 1 of initiation of read data output corresponding to queue #1. At T7 and et seq., a similar process is carried out.

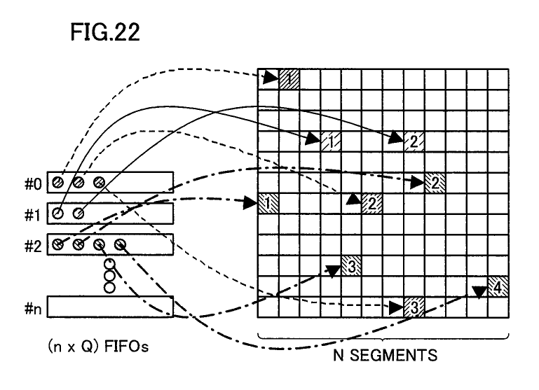

FIG. 22 represents the correspondence between queues #0 to #n and the memory in which actual packet data is stored. The left part in FIG. 22 represents queues #0 to #n, and the right part in FIG. 22 represents a memory in which actual data of packets are stored. For example, three packets (1-3) stored at queue #0 are to be stored in discontinuous regions on the memory.

By administration of only the memory address at a queue, the memory size of each queue can be rendered variable. The capacity of a DRAM or SRAM can be utilized efficiently.

It is to be noted that the burst length of data FIFO employed in writing or reading is variable, not fixed. For network equipment, the data input/output with respect to an external source is a packet or frame whose data length is not known until data is received. Control is facilitated by rendering variable the length of the data FIFO where data is temporarily stored.

The above description is based on the case where storage device 30 writes packet data into a DRAM or SRAM. Alternatively, the odd segment in a packet may be written into a SRAM and other major segments may be written into a DRAM, as described in the first to third embodiments.

According to the storage device of the fourth embodiment, packet data writing and reading are carried out upon receiving a queue number. Therefore, control by the network processor can be simplified.

Further, since only writing and reading of packet data is carried out with respect to an external memory, the number of times of access towards the memory can be reduced, allowing reduction in power consumption.

### Fifth Embodiment

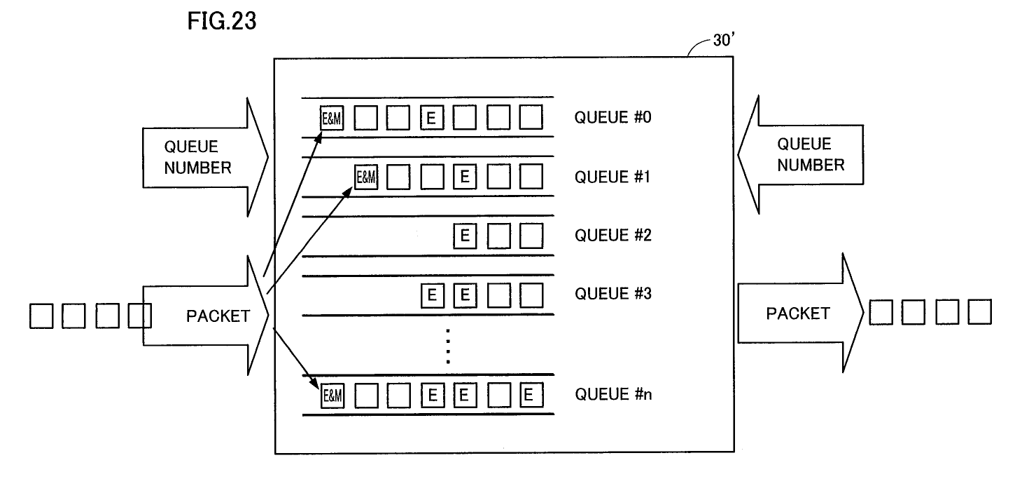

FIG. 23 is a diagram to describe a basic concept of a storage device according to a fifth embodiment of the present invention. When packet data is to be input, storage device 30′ receives only the externally-applied packet data and the queue number where the data is to be stored, and then stores the data in the corresponding queue. When packet data is to be output, storage device 30′ receives only an externally-applied queue number, and reads out the packet data from the queue corresponding to that queue number for output to an external source.

The storage device of the fifth embodiment differs from storage device 30 of the first embodiment shown in FIG. 18 in that packet data applied from one port can be output to a plurality of ports. Referring to FIG. 23, the seventh segment from the right in queue #0 with “E&M” indicates that it is the last segment in one packet and also that the second packet corresponds to a multicast packet that will be output to a plurality of ports.

Storage device 30′ of the fifth embodiment differs from the storage device of the fourth embodiment shown in FIG. 19 only in the function of the address generator. Therefore, description of similar configurations and functions will not be repeated. In the present embodiment, the address generator will be described taking the reference number 35′.

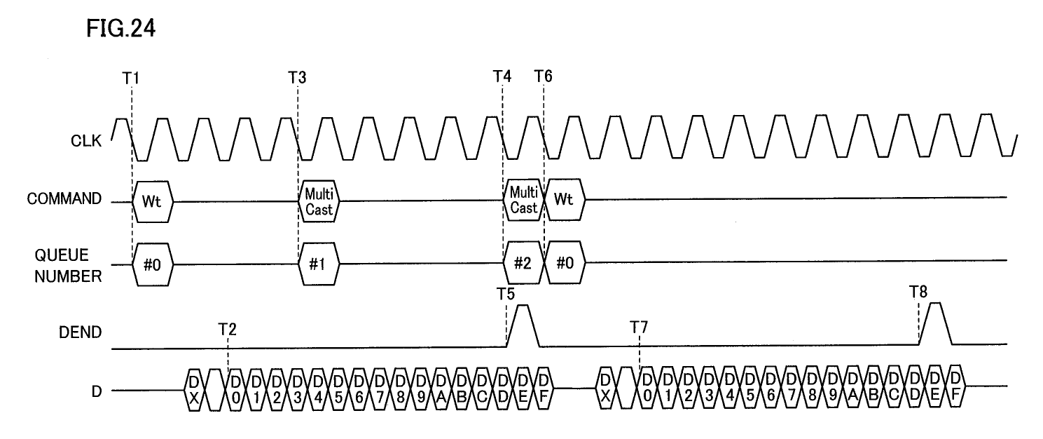

FIG. 24 is a timing chart to describe a packet data writing operation in a storage device according to the fifth embodiment. At T1, command controller 31 initiates writing of packet data upon receiving a write command (Wt) and a queue number (#0) from network processor 1.

When effective data is input at T2 and et seq., data FIFO 39 stores packet data (D0-DF), which is sequentially output to a DRAM or SRAM via data FIFO 40 or FIFO 41.

At T3, when command controller 31 receives a multicast command and a queue number (#1) from network processor 1, address generator 35′ updates, for the purpose of storing data of the currently writing packet to queue #1, the value of the tail pointer at queue #1 similarly to the value of the tail pointer at queue #0, and updates the link list of queue #1 similarly to the link list of queue #0. Link list storage 52 is updated so as to establish link to the same packet data.

At T4, when command controller 31 receives a multicast command and queue number (#2) from network processor 1, address generator 35′ updates, for the purpose of storing data of the currently writing packet to queue #2, the value of the tail pointer at queue #2 similarly to the value of the tail pointer at queue #0, and updates the link list of queue #2 similarly to the link list of queue #0. Link list storage 52 is updated so as to establish link to the same packet data.

At T5, when command controller 31 receives signal DEND, packet length counter 32 and data FIFO 39 are notified that packet data writing has ended. Packet length manager 33 stores the packet length received from packet length counter 32 into packet length storage 34.

At T6, when command controller 31 receives a write command (Wt) and a queue number (#0) from network processor 1, writing of packet data is initiated. Subsequently, a similar process is carried out.

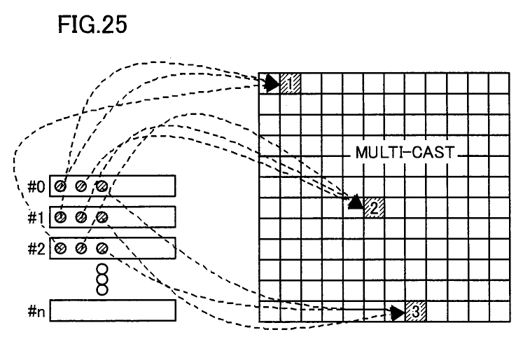

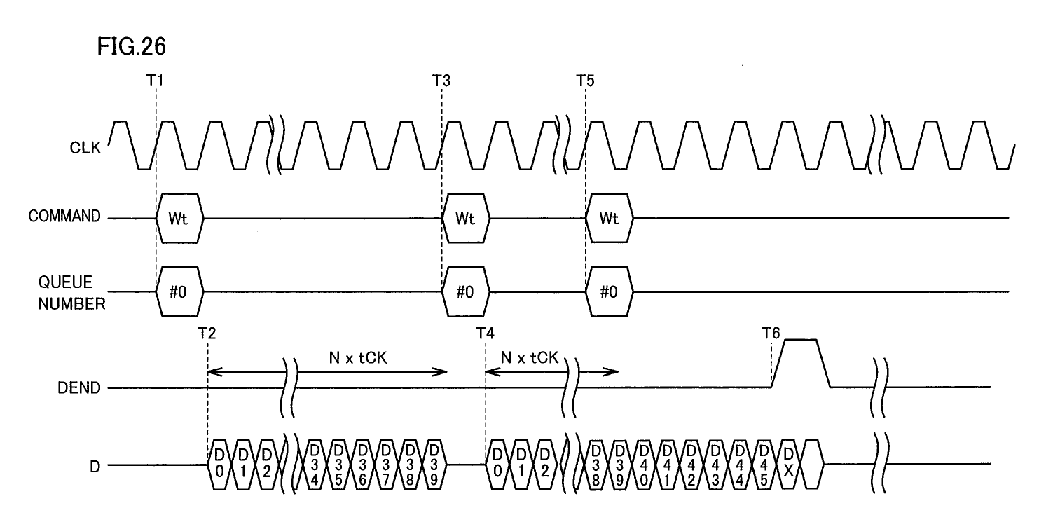

FIG. 25 represents the correspondence between queues #0-#n and a memory in which actual data of a multicast packet are stored. In FIG. 25, the left part represents queues #0 to #n, and the right part represents a memory in which actual multicast packet data are stored. For example, three packets (1-3) located at queue #0 are to be stored in discontinuous regions on the memory. These three packets are multicast packets. The pointers of the three packets stored at queue #1 and queue #2 represent the link to the address where respective packets (1-3) are to be stored.

In the case where a multicast packet is to be read out, information indicating by how many queues the packet is shared is maintained. When the number of times the multicast packet has been read out matches the number of queues sharing the multicast packet, the addresses of the DRAM or SRAM where the multicast packet was stored are to be freed.

When a multicast packet is to be written in queues according to the storage device of the present embodiment, the packet data is written only once into an external memory, and the pointer of each queue is linked with the address where the packet has been written. Therefore, in addition to the advantages described with respect to the fourth embodiment, the number of times of access to an external memory can be further reduced, allowing power consumption to be further reduced.

Since a multicast packet is written only once into an external memory, the event of shortage in empty space in a memory can be prevented.

### Sixth Embodiment

The storage device of the fourth embodiment is directed to writing or reading data of one packet with one command. The storage device of the sixth embodiment is directed to writing data of just a predetermined amount with one write command.

The storage device of the sixth embodiment differs from the storage device of the fourth embodiment shown in FIG. 19 only in the function of the command controller. Therefore, description of similar configurations and functions will not be repeated. In the present embodiment, the command controller will be described taking the reference number 31″.

FIG. 26 is a timing chart to describe a packet data writing operation in the storage device according to the sixth embodiment. Referring to FIG. 26, a write command is issued from network processor 1 every time packet data of 40 segments are written.

At T1, when command controller 31″ receives a write command (Wt) and a queue number (#0) from network processor 1, writing of packet data of the first 40 segments is initiated.

When effective data is input at T2 and et seq., data FIFO 39 stores packet data (D0-D39), which is sequentially output to a DRAM or SRAM via data FIFO 40 or FIFO 41.

At T3, when command controller 31″ receives a write command (Wt) and queue number (#0) from network processor 1 again, writing of packet data of the next 40 segments is initiated.

When effective data is input at T4 and et seq., data FIFO 39 stores packet data (D0-D39), which is sequentially output to a DRAM or SRAM via data FIFO 40 or FIFO 41.

At T5, when command controller 31″ receives a write command (Wt) and queue number (#0) from network processor 1, writing of the remaining segments in a packet is initiated. FIG. 26 represents the case where there are odd segments D40-D45.

At T6, when command controller 31″ receives signal DEND, packet length counter 32 and data FIFO 39 are notified that packet data writing has ended. Packet length manager 33 stores the packet length received from packet length counter 32 to packet length storage 34.

FIG. 26 corresponds to the case where network processor 1 issues a write command to the storage device and any last odd segments, short of a constant amount, are certainly written to an external memory. However, in lieu of issuing the last write command from network processor 1, the odd segments may be added to the last data of the constant amount to be written into an external memory together as data longer than the constant amount.

According to the storage device of the present embodiment, writing data of only a constant amount is effected by one write command. Therefore, advantages similar to those described with reference to the fourth embodiment can be provided.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A storage device connected to a first storage unit, and dividing a packet received via a network into a plurality of segments for storage, said storage device comprising:
a second storage unit capable of faster access than said first storage unit, and
a write section for writing a first predetermined number of segments in said packet to said second storage unit, and a subsequent segment to said first storage unit.

2. The storage device according to claim 1, wherein said write section includes
a counter for counting a number of segments to be written,
a plurality of buffers for storing a segment to be written into said first storage unit, and
a selector for referring to a count value in said counter to provide the first predetermined number of segments in said packet to said second storage unit, and a subsequent segment sequentially to said plurality of buffers.

3. The storage device according to claim 2, wherein
said first storage unit is capable of writing a plurality of segments in parallel, and
said plurality of buffers are provided corresponding to a number of segments that can be written into said first storage unit in parallel.

4. The storage device according to claim 3, wherein said predetermined number is the number of segments that can be written into said first storage unit in parallel minus 1.

5. The storage device according to claim 1, further comprising a read section for reading out the first predetermined number of segments in said packet stored in said second storage unit for output, and then reading out a subsequent segment stored in said first storage unit for output.

6. The storage device according to claim 5, wherein said read section includes
a counter for counting a number of segments to be read out,
a plurality of buffers for storing a segment read out from said first storage unit, and
a selector referring to a count value of said counter for reading out the first predetermined number of segments in said packet from said second storage unit for sequential output, and then reading out a subsequent segment from said plurality of buffers for sequential output.

7. The storage device according to claim 6, wherein
said first storage unit is capable of reading out a plurality of segments in parallel, and
said plurality of buffers are provided corresponding to a number of segments that can be read out in parallel from said first storage unit.

8. A storage device, connected to a first storage unit, and dividing a packet received via a network into a plurality of segments for storage, said storage device comprising:
a second storage unit capable of faster access than said first storage unit, and
a write section for writing every predetermined number of segments in said packet to said first storage unit, and a last odd segment to said second storage unit.

9. The storage device according to claim 8, wherein said write section includes
a counter for counting a number of segments to be written,
a plurality of buffers for storing a segment to be written into said first storage unit, and
a selector for referring to a count value in said counter to provide the predetermined number of segments in said packet to said plurality of buffers, and the last odd segment sequentially to said second storage unit.

10. The storage device according to claim 9, wherein
said first storage unit is capable of writing a plurality of segments in parallel, and
said plurality of buffers are provided corresponding to a number of segments that can be written into said first storage unit in parallel.

11. The storage device according to claim 10, wherein said predetermined number is the number of segments that can be written into said first storage unit in parallel.

12. The storage device according to claim 8, further comprising a read section for reading out the predetermined number of segments in said packet stored in said first storage unit for output, and then reading out the last odd segment stored in said second storage unit for output.

13. The storage device according to claim 12, wherein said read section includes
a counter for counting a number of segments to be read out,
a plurality of buffers for storing a segment read out from said first storage unit, and
a selector for referring to a count value of said counter to read out the predetermined number of segments in said packet from said plurality of buffers for sequential output, and to read out the last odd segment from said second storage unit for sequential output.

14. The storage device according to claim 13, wherein
said first storage unit is capable of reading out a plurality of segments in parallel, and
said plurality of buffers are provided corresponding to a number of segments that can be read out in parallel from said first storage unit.

15. A storage device connected to a first storage unit, and dividing a packet received via a network into a plurality of segments for storage, said storage device comprising:
a second storage unit capable of faster access than said first storage unit, and
a write section for writing, when a number of segments in said packet is equal to or greater than the predetermined number, said predetermined number of segments in said packet to said first storage unit, and then writing a last odd segment to said first storage unit in a page mode, and when the number of segments in said packet is less than said predetermined number, the packet into said second storage unit.

16. The storage device according to claim 15, further comprising a read section for reading, when the number of segments in said packet is equal to or greater than the predetermined number, said predetermined number of segments in said packet from said first storage unit for output, and then the last odd segment from said first storage unit in the page mode for output, and when the number of segments in said packet is less than said predetermined number, the packet from said second storage unit for output.

17. A storage device connected to a first storage unit, and dividing a packet received via a network into a plurality of segments for storage, said storage device comprising:
a second storage unit capable of faster access than said first storage unit, and
a write section for writing last predetermined number of segments in said packet to said second storage unit, and writing any previous segments to said first storage unit.

18. A storage device storing data of a packet received via a network into an external memory, said storage device comprising:
a controller for receiving an externally-applied write command and a queue number to control writing of said packet data,
an address generator for obtaining an empty address in said external memory for output to update a value of a pointer corresponding to the queue number received by said controller for linking to said obtained empty address, and
a memory manager for writing said packet data into said external memory according to the empty address output from said address generator.

19. The storage device according to claim 18, further comprising:
a counter for counting a packet length of said packet, and
a packet length manager for governing the packet length counted by said counter.

20. The storage device according to claim 18, wherein, when said controller receives an externally-applied multicast command and a second queue number, said address generator links an address in said external memory where said packet data is written to a value of a pointer corresponding to said second queue number.

21. The storage device according to claim 18, wherein said controller receives the externally-applied write command and the queue number at every writing of data of a constant amount of said packet data.

22. The storage device according to claim 19, wherein
said controller receives an externally-applied read out command and a queue number to control reading of data in said packet,
said address generator refers to a value of a pointer corresponding to the queue number received by said controller for obtaining and providing an address in said external memory where said packet data is stored, and
said memory manager reads out from said external memory the data of the packet length governed by said packet length manager, according to the address output from said address generator.

23. The storage device according to claim 19, further comprising a buffer provided corresponding to said external memory, wherein
said packet data is transferred to said external memory via said buffer during said writing, and
said controller controls a burst length of said buffer corresponding to the packet length of said packet.
